(19) United States
(12) Patent Application Publication
(10) Pub. No.: US 2004/0172150 A1
(43) Pub. Date: Sep. 2, 2004

(54) System and method for virtual articulator

(76) Inventors: Jean-Marc Perot, Montreal (CA); Hugo Romain Embert, Montreal (CA); Francois Marcil, Outremont (CA)

Correspondence Address: OGILVY RENAULT, 1981 MCGILL COLLEGE AVENUE, SUITE 1600, MONTREAL, QC, H3A2Y3, CA

(21) Appl. No.: 10/734,263

(22) Filed: Dec. 15, 2003

Related U.S. Application Data
(63) Continuation of application No. PCT/CA02/00904, filed on Jun. 14, 2002.

(30) Foreign Application Priority Data
Jun. 15, 2001 (CA) 2,350,849

(51) Int. Cl. A61C 11/00

(52) U.S. Cl. 700/98; 433/213

(57) ABSTRACT

A system and method are taught for designing a change to a virtual dental model comprising: a virtual articulator representing a three dimensional model of a patient's upper and lower dental arches including data defining a constraint of motion between the upper and lower dental arches; a simulation analyzer to simulate the motion using the three dimensional model and analyze resulting contacts on portions of the upper and lower arches during the movement to provide contact data; and a designing module to design one of a virtual prosthesis for one of said upper and lower arches and a virtual desired dental modification using the contact data acquired from the simulation analyzer and the virtual articulator.

### CROSS REFERENCE TO RELATED APPLICATION

This application is a continuation of PCT application number PCT/CA02/00904 filed Jun. 14, 2002 and claiming priority of Canadian Patent application number 2,350,849 filed Jun. 15, 2001.

### FIELD OF THE INVENTION

The invention relates to virtual dental models. More specifically, it relates to providing virtual dental models based on mechanical articulators, simulating the dental models virtually, and designing virtual prostheses for the virtual dental models.

### BACKGROUND OF THE INVENTION

An articulator is an apparatus that allows one to reproduce mechanically, more or less precisely, the kinematics involved in jaw motion. It comprises an upper and a lower portion. The upper portion represents the upper section of the jaw and the condylar boxes; the lower portion represents the lower mandibular and the condyles. The articulator is said to be an anatomical representation of the lower portion of the face.

To respect the anatomical nature of the articulator, each model mounted within it is done so with respect to a reference plane that can be superimposed on the apparatus and the patient. This reference plane is defined by three points: the two protrusions under the skin at the condyles lying on the hinge axes, and an infra-orbital point taken at the lowest location of one of the orbits. To transfer a dental model of an upper arch onto an articulator in the same spatial relation as it is to the cranium, a face-bow is typically used. The face-bow can be referenced with respect to a localized hinge axis or an arbitrary hinge axis.

Articulators which use different reference planes also exist. The use of such physical tools is limited due to costly production costs and the complex nature of any useful information.

Furthermore, the mechanical articulators cannot accurately represent the anatomy and physiology of a patient. The condyle receptacles do not have the exact concave shape of the temporal fossa and condyles are not the same oval shape as the mandibular condyles. The motion constraints imposed by the mechanical articulator do not allow proper analysis of the patient's actual articulation.

Moreover, when a prosthesis is designed, the data provided by the mechanical articulators is limited. It would be advantageous to provide a tool that could take advantage of a mechanical articulator and provide useful data for the design of a prosthesis.

### SUMMARY OF THE INVENTION

Accordingly, an object of the present invention is to combine the use of a virtual articulator with computer-aided design to design a prosthesis or a desired dental modification.

Another object of the present invention is to combine the use of a virtual articulator and computer-aided design with computer-aided fabrication to provide a fabricated product.

Yet another object of the present invention is to correlate an upper dental arch to a lower dental arch in a virtual environment.

According to a first broad aspect of the present invention, there is provided a system for designing a change to a virtual dental model comprising: a virtual articulator representing a three dimensional model of a patient's upper and lower dental arches including data defining a constraint of motion between the upper and lower dental arches; a simulation analyzer to simulate the motion using the three dimensional model and analyze resulting contacts on portions of the upper and lower arches during the movement to provide contact data; and a designing module to design one of a virtual prosthesis for one of said upper and lower arches and a virtual desired dental modification using the contact data acquired from the simulation analyzer and the virtual articulator.

Preferably, one of a virtual prosthesis and a virtual desired dental modification are implemented in the three dimensional model to create a modified three dimensional model and the modified three dimensional model is simulated to analyze new resulting contacts. A fabrication module to fabricate the prosthesis based on a design made by the designing module is also provided.

According to a second broad aspect of the present invention, there is provided a method for determining a satisfactory change to a virtual dental model comprising: (a) creating a virtual three dimensional dental model including parameters defining a constraint of motion between an upper and a lower dental arch; (b) simulating movement of the dental model while respecting the parameters to identify points of contact between portions of an upper and a lower dental arch; (c) designing a change to the dental model taking into consideration the contact using a computer aided design system; and (d) repeating as desired steps (b) and (c) to obtain a satisfactory changed dental model.

Preferably, creating a virtual three dimensional model further comprises creating a virtual three dimensional model with respect to a mechanical articulator. Points of contact may also be forces of contacts, and the points and forces of contacts can be identified by virtual markers such as arrows differing in direction, length, and color.

According to a third broad aspect of the present invention, there is provided a method for correlating an upper dental arch to a lower dental arch comprising: creating a physical dental model of the upper dental arch and the lower dental arch; digitizing the physical upper dental arch along with reference markers referenced with respect to the physical lower dental arch model; digitizing the physical lower dental arch along with reference markers with respect to the physical upper dental arch model; and calculating transition matrices correlating the upper dental arch and the lower dental arch.

Preferably, the method further comprises applying a malleable material to the upper dental arch and the lower dental arch so as to create a bite impression of each in a desired occlusion position, the malleable material having the reference markers protruding from the dental model to provide an external referential system; and wherein the digitizing is done with the malleable material and without the malleable material.

According to the invention, there is provided a computer readable memory for storing programmable instructions for use in the execution in a computer of the methods described herein.

Also according to the invention, there is provided a computer data signal embodied in a carrier wave comprising data resulting from simulating movement of the dental model while respecting the parameters to identify points of contact between portions of an upper and a lower dental arch or from designing a change to the dental model taking into consideration the contact using a computer aided design system.

### BRIEF DESCRIPTION OF THE DRAWINGS

These and other features, aspects and advantages of the present invention will become better understood with regard to the following description and accompanying drawings wherein:

FIG. 1 is a mechanical articulator;

FIG. 2 is a schematic of an upper and a lower dental arch model;

FIG. 3 is a schematic of the dental arches with an external referential system;

FIG. 4A is the lower dental arch with the reference system;

FIG. 4B is the lower dental arch without the reference system;

FIG. 4C is the upper dental arch with the reference system;

FIG. 4D is the upper dental arch without the reference system;

FIG. 5A is a front and side view of the mechanical articulator;

FIG. 5B is a side view of the mechanical articulator with the positioning table;

FIG. 5C is a side view of the mechanical articulator with the dental arches;

FIG. 6A is the transfer plate;

FIG. 6B is the transfer plate with a dental arch place on it;

FIG. 7 is a virtual model of a portion of a dental arch;

FIG. 8 is a virtual articulator with a positioning table;

FIG. 9 is a virtual articulator with both dental arches in place;

FIG. 10 is a screen shot of setting the parameters for the virtual articulator;

FIG. 11 is a screen shot of setting the parameters for the virtual articulator;

FIG. 12 is a virtual tooth with points of contacts and force vectors illustrated;

FIG. 13 is a virtual prosthesis on a virtual dental arch.

### DETAILED DESCRIPTION OF THE PREFERRED EMBODIMENT

Throughout this application, the preferred embodiment of the present invention will be referred to as a “virtual articulator”. A virtual articulator is a three dimensional virtual representation of the upper and lower dental arches in spatial relation to each other, and comprising motion constraints. A “virtual occlusor” is a three dimensional virtual representation of the upper and lower dental arches in spatial relation to each other. It can be appreciated that an upper or lower arch can be an entire arch or a portion of an arch. It can also be appreciated that although the preferred embodiment refers to the design and fabrication of a prosthesis, an implant can easily be designed and fabricated using the described system and method.

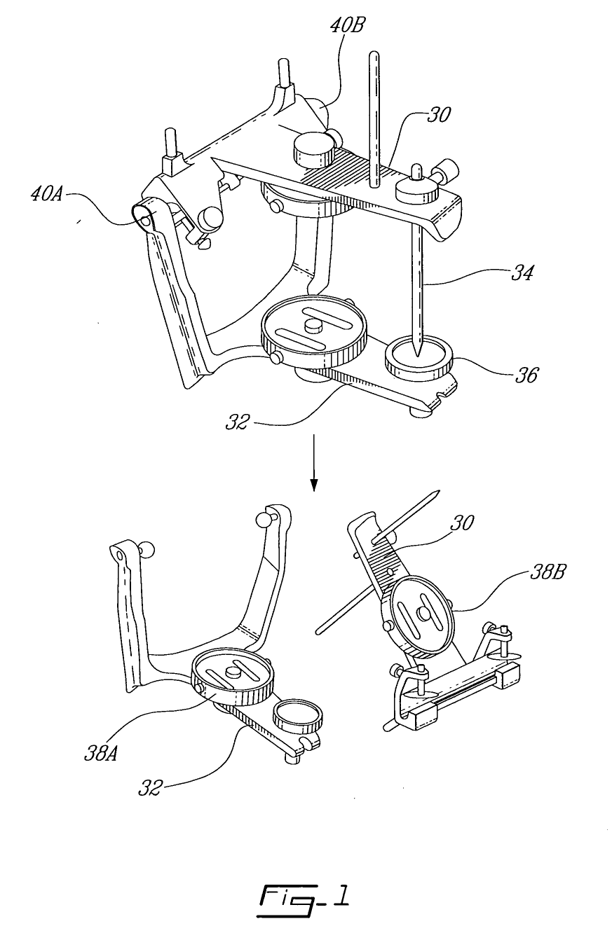

FIG. 1 shows a mechanical articulator. The upper section 30 represents the upper jaw of a patient. The lower section 32 represents the lower jaw of the patient. The two are separated by a rod 34, called an incisal rod. A rotating knob 36 on the rod can bring the upper and lower sections closer together or further apart. On each of the upper and lower sections, there is a small, round table, called a positioning plate 38a & 38b. These plates are where each of the dental models representing the upper arch and lower arches are placed. The upper and lower sections are also connected by joints 40a & 40b that represent the condyles that link the upper and lower mandibles together and reproduce condylar movement.

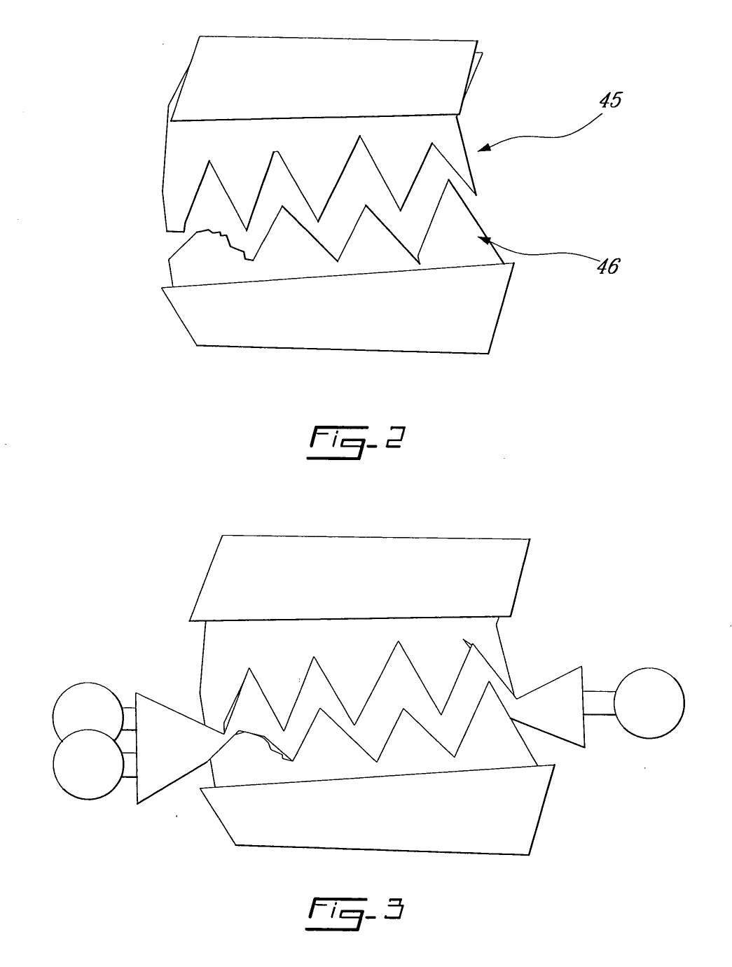

Dental Models taken with impressions and poured in dental stone, such as those seen in FIG. 2, are placed on the machine either for examination and diagnosis, or to construct dental appliances.

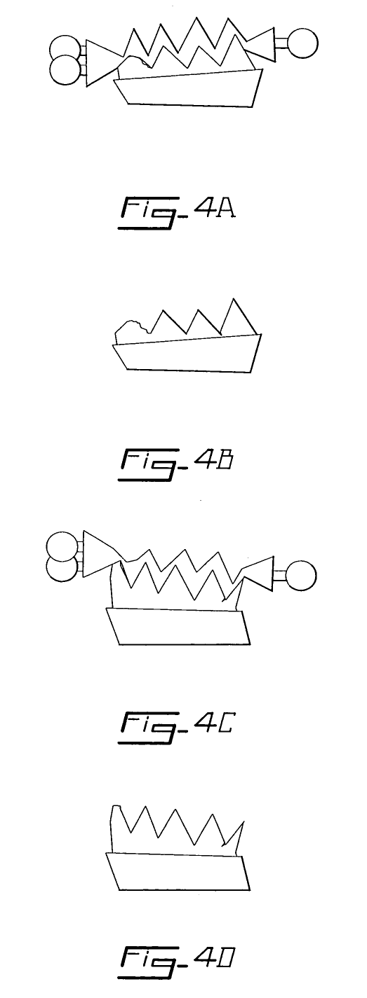

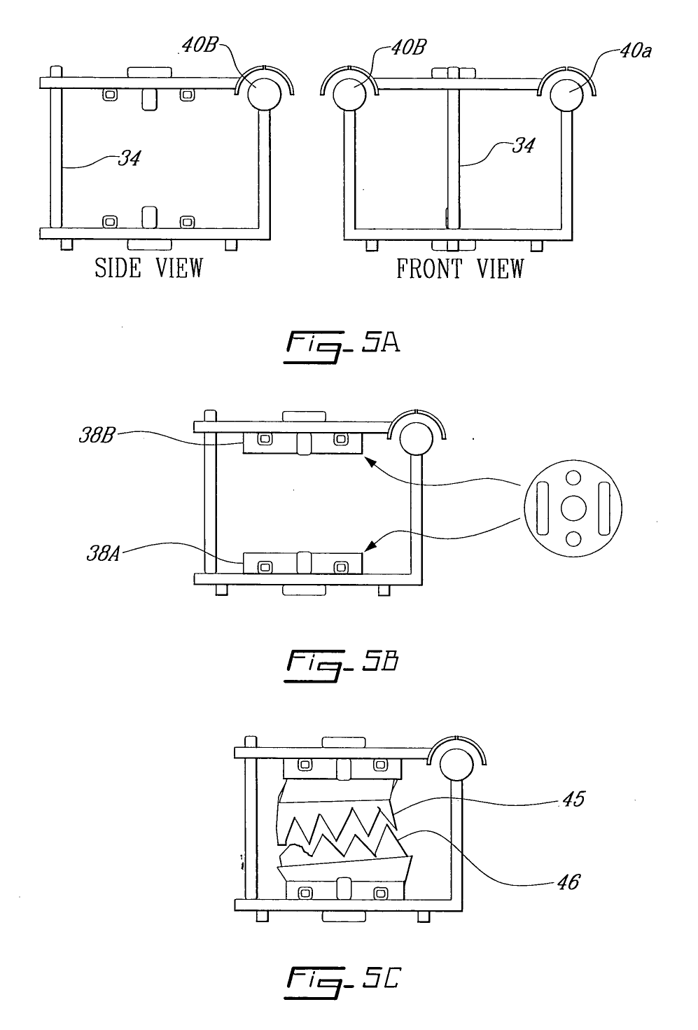

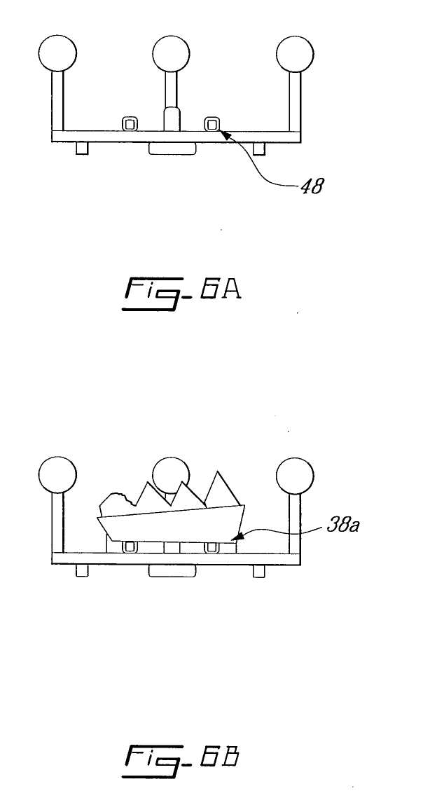

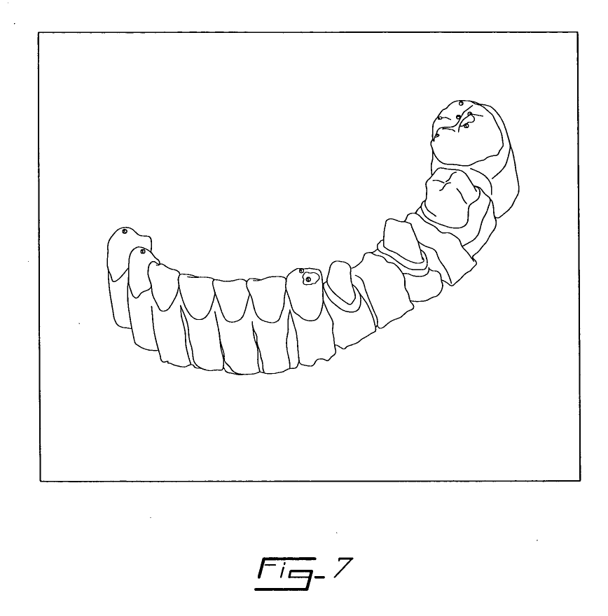

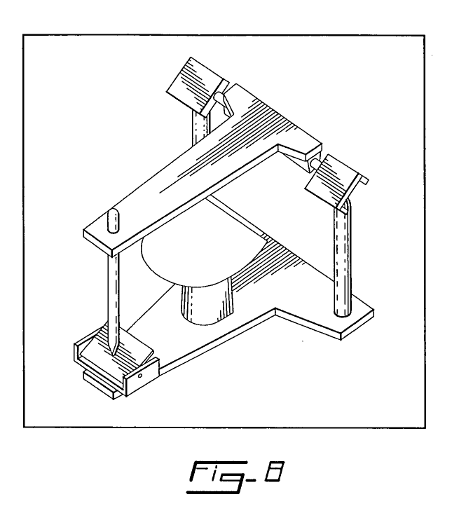

A virtual articulator is constructed either from a mechanical articulator or with data taken directly from a patient. If the data is taken from the mechanical articulator, or the physical dental models, each of the dental arches is scanned to provide digital data representing the bite impression. In order to reference one arch with respect to the other, an object comprising an external referential system is placed on each of the dental arches. This is done by placing a malleable material in between the arches and pressing down on them to place them in a position of occlusion, registering a bite impression on the material, as seen in FIG. 3. Reference markers, such as spheres, are used to act as the external reference system. The spheres, which protrude from the two arches, do not lie in the same plane. Each of the arches is digitized with and without the referential system (FIGS. 4a-4d). The referential system becomes the link between the two arches. Transition matrices are calculated from one marker to the other in order to position the virtual representations of the dental arches with respect to each other.

The reference markers used do not have to be spheres. Any polyhedron can be used, as long as there are always at least three visible faces from any point in space. In the case of spheres, different sizes in diameters allow each sphere to be identified and referenced separately, if necessary. When the spheres are digitized, the center of each sphere is determined as well as its diameter. Furthermore, the reference markers can be ultrasonic, magnetic emitters, passive reflectors, etc.

FIG. 5 shows a schematic representation of a mechanical articulator. In the mechanical articulator, the relationship between the joints representing the condyles 40a & 40b, and the branches on which the dental arches reside 30 & 32 is known. In order to place the virtual dental arches properly within the virtual articulator, it is necessary to find the spatial relationship between the arches and the branches of the mechanical articulator. This is done using transfer plates. The dental arches are mounted onto positioning plates 38a & 38b which are themselves mounted onto the branches of the mechanical articulator. If we consider the mechanical characteristics of the articulator to be constant and known, then we can consider the position and orientation of the positioning plates to be known. That is, we can relate the position and orientation of the planes formed by the branches of the mechanical articulator with respect to the rotational axis of articulation to the positioning plates and therefore, to the dental arches. This leads to the position and orientation of the dental arches with respect to the mechanical articulator. In order to reposition in space the dental arches with respect to the positioning plates, a transfer plate is used.

The basic principle consists in placing the positioning plates supporting the arches on a transfer plate having the same parameters and characteristics as the mechanical articulator. The transfer plates have the same rivets as the articulator branches, on which the positioning plates are placed. We consider the position of the rivets with respect to the transfer plates to be known.

The transfer plates comprise reference markers, as seen in FIG. 6a. The planes passing through each reference marker are known. Also known are the planes in which the transfer plate lies and the positioning rivets 48 lie with respect to the planes passing through each reference marker. Therefore, the position of the branches of the mechanical articulator with respect to the center of each marker is known. By digitizing the dental arches on the transfer plate with each reference marker, as shown in FIG. 6b, the spatial relationship between the dental arches and the branches of the mechanical articulator is known. It is then possible to orient and position the virtual dental arches within the virtual articulator.

The reference markers used for the transfer plate may be spheres or polyhedrons having 3 faces visible from all points in space at all times. In the case of spheres, different diameters allow the system to recognize the orientation of the plate in space automatically by distinguishing one sphere from the other.

Different types of transfer plates may be used. The principle applied to all transfer plates is to reference the plate in space while acquiring the data. The reference markers can be ultrasound transceivers, passive emitters that reflect light, magnetic emitters, encoders (such as MOCN), or others.

The transfer plates may be standard or personalized. For standard plates, the dimensions are predefined and pre-calibrated. The reference markers are fixed upon construction of the plate. For personalized plates, the user has the possibility of editing the transfer plate. For example, the position of the reference markers can be adjusted. This is to allow the use of the plates in abnormal clinical situations where a model is particularly misaligned or abnormally large with respect to the positioning plates. The reference markers can then be set at different heights and the digitizing tool can then be used as a calibration tool for the transfer plate.

The data necessary to create the virtual articulator can also be taken directly from a patient. Such data can be gathered from medical images, such as x-rays and computerized-tomography scans. Digitizing can also be done directly from the mouth of the patient, with the data transferred directly to a computer. The data can also come from statistical averages of different populations. The face-bow may also be used to gather data. Sensors, such as optical or other types, can be placed inside the mouth to capture the physiology of the dental arches.

The described method and system allows for the combination of different data acquisition methods. For example, more precise data obtained from the physical dental models can be integrated with 3D reconstructions based on medical imagery information by determining the positions which minimize the differences between the two sets of data.

The result of the data acquisition can be seen in FIG. 7. A virtual model of a dental arch is shown, with teeth missing in the corresponding locations and with the correct morphology of each tooth and piece of gum.

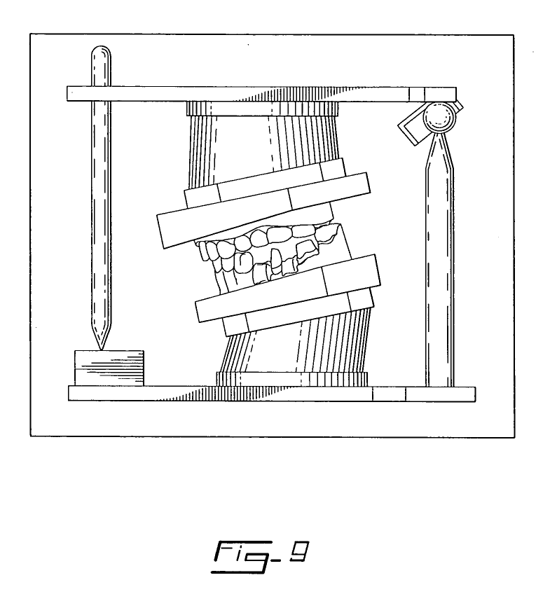

FIG. 8 shows a virtual representation of an articulator with a positioning table before the dental arches are placed on it. FIG. 9 shows a side view of the virtual articulator with the virtual dental arches on the positioning tables.

Once the virtual articulator has been created, we have a virtual three dimensional model of a patient's upper and lower dental arches including data defining a constraint of motion between the upper and lower dental arches, as shown in figure. Algorithms are used for mathematical modeling of the geometry and shapes of objects constituting a person's articulation, as well as their respective positions and orientations in space.

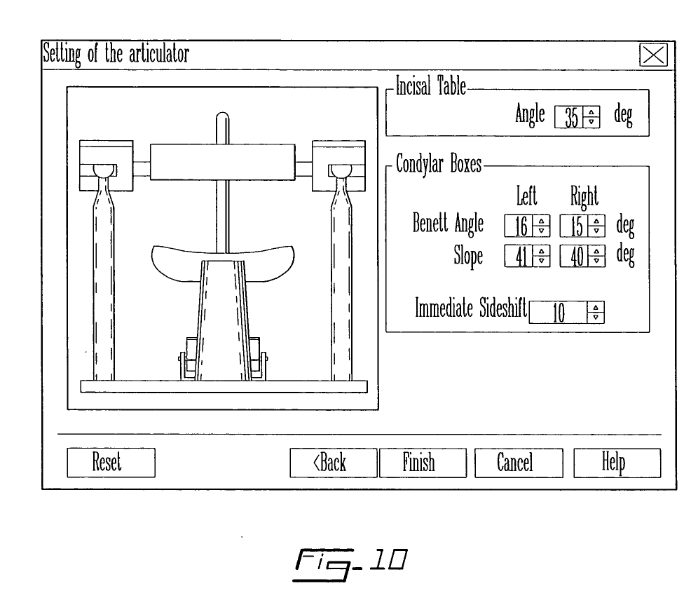

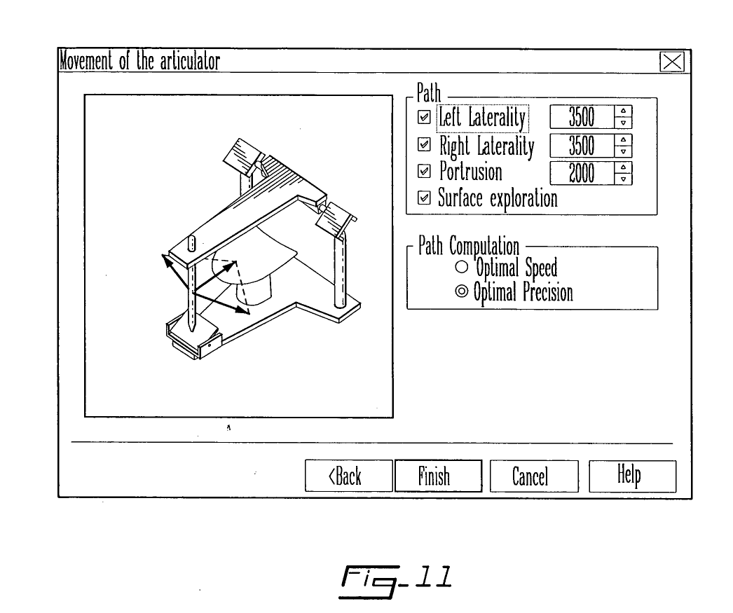

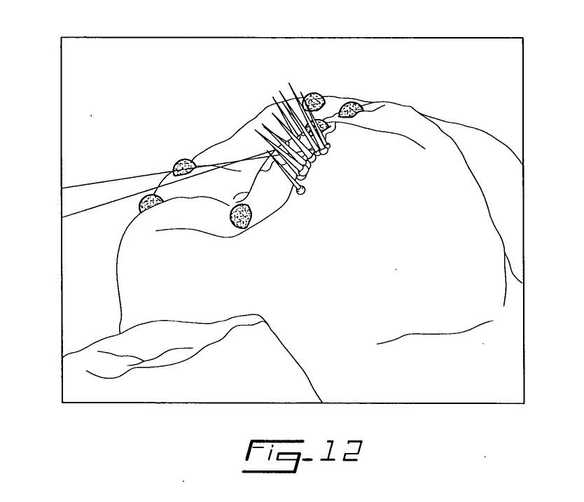

Various parameters included in the modeling are the condylar slope, the height and spacing of the condyles, lateral spacing, the Bennett angle, the Guichet cone, the incision slope, the position of the positioning tables, the setting of the incisal rod, etc. Clinical parameters such as the shape of the dental arches and the position of the arches within the articulation are also considered. Motions produced such as left laterality, right laterality, propulsion of the mandible, retropulsion of the mandible, and free motion are also modeled by algorithms. FIGS. 10 and 11 illustrate screen shots demonstrating how the virtual articulator can be set with various parameters.

Modeling can include the entire jaw as well as various tissues and bones, such as cartilage, muscles, and ligaments, and characterize them with respect to density, muscular tone, laxity of the ligaments, and so on.

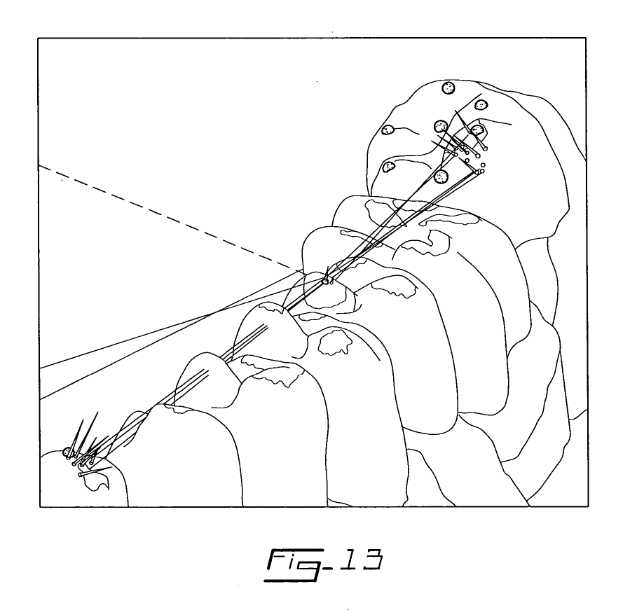

Simulations of the articulation can be done. A simulation involves reproducing the kinematics involved in the regular motions performed by the jaw of a person. A simulation analyzer analyzes the resulting forces on portions of the virtual upper and lower arches during the movement. Points of contact between the teeth are identified. Forces relating to the contacts are also identified. Strength and direction of the forces are determined and marked using virtual markers. The markers can take many forms, such as arrows representing vectors. The arrows can vary in direction, length, and color, to differentiate between the forces, their orientation, and their strength. FIG. 12 illustrates the force vectors and points of contact on a tooth.

In the virtual environment, it is also possible to determine the order of occurrence of the forces. For example, which point of contact occurs first and the difference in time between two consecutive points of contact.

The modeling engine described considers the dynamic relationships between the dental arches and their antagonists with respect to the inter-occlusive curves and in a maximum state of intercuspidation. It also considers the dental relationships due to lateral excursion and propulsion and identifies different types of interference and defects due to the relative guiding of the teeth and the functions of each tooth.

Changes can also be made to the virtual dental model. Teeth can be removed or simply sanded down or trimmed. The simulations are then run again and the different resulting contacts are analyzed. An ideal or satisfactory change is decided upon by comparison of the different simulations. In some cases, the change which requires the less potential damage to a patient is chosen. In other cases, it is the change resulting in the most ideal result that is chosen.

The information produced by the simulation analyzer, i.e. the contact data, is used by a designing module to design either a virtual prosthesis or a dental modification. The change can be to a portion of an arch or to an entire arch. If a virtual prosthesis is designed, it is then implemented in the virtual three dimensional model to create a modified three dimensional model, the new model is simulated, and the new resulting contacts are analyzed.

Several different changes can be attempted and simulated in order to choose the best result. The different implementations of the changes are stored in the system and can be called upon when requested. They can be compared in order to choose a satisfactory change. FIG. 13 shows a prosthesis placed on a dental arch and the analysis of the resulting forces.

The coupling of the virtual articulator with a design module allows a better integration of a prosthesis and a dental arch by minimizing detrimental forces on the prosthesis (such as lateral forces), thereby increasing the long-term duration of the prosthesis and reducing costs associated with these types of treatments.

The modeling engine can be coupled with a constraint analysis program to analyze the sequence of contacts and the work done upon each contact. This can determine the evolution in time of the applied forces on the different elements in the jaw as well as the wear incurred. This analysis can be done using a finite element method. This method allows the calculation of different forces present, external forces as well as the distribution of internal constraints.

Once a change has been chosen and a virtual prosthesis has been designed, a fabrication module can use the data produced by the designing module to fabricate an actual prosthesis. The fabrication module may be a computer-assisted module.

While illustrated in the block diagrams as ensembles of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

We claim:

1. A system for designing a virtual dental model comprising:
a virtual articulator representing a three dimensional model of a patient's upper and lower dental arches including data defining a constraint of motion having a plurality of degrees of freedom between said upper and lower dental arches;
a simulation analyzer to simulate said motion using said three dimensional model and analyze resulting contacts on portions of said upper and lower arches during said movement to provide contact data, said resulting contacts being characterized by a sequence in time of occurrence; and
a designing module to design one of a virtual prosthesis for one of said upper and lower arches and a virtual desired dental modification using said contact data acquired from said simulation analyzer and said virtual articulator.

2. A system as claimed in claim 1, wherein said one of a virtual prosthesis and a virtual desired dental modification are implemented in said three dimensional model to create a modified three dimensional model and said modified three dimensional model is simulated to analyze new resulting contacts.

3. A system as claimed in claim 2, wherein a plurality of modified three dimensional models are created and stored.

4. A system as claimed in claim 1, wherein said resulting contacts are one of points of contact and forces of contact.

5. A system as claimed in claim 4, wherein said resulting contacts are identified by markers with different directions, lengths and colors.

6. A system as claimed in claim 1, further comprising a three-dimensional model generator of a patient's upper and lower dental arches, the generator comprising:
a physical dental model of said upper dental arch and said lower dental arch;
reference markers referenced with respect to said physical lower dental arch model;
reference markers referenced with respect to said physical upper dental arch model;
digitizing means for digitizing said physical upper dental arch along with reference markers referenced with respect to said physical lower dental arch model and for digitizing said physical lower dental arch along with reference markers referenced with respect to said physical upper dental arch model; and
calculating means for calculating transition matrices correlating said upper dental arch and said lower dental arch so as to generate a three-dimensional model.

7. A system as claimed in claim 6, further comprising a fabrication module to fabricate said prosthesis based on a design made by said designing module.

8. A system as claimed in claim 7, wherein said design made by said designing module is chosen from said plurality of modified three dimensional models.

9. A method for determining a satisfactory change to a virtual dental model comprising:
(a) creating a virtual three dimensional dental model including parameters defining a constraint of motion having a plurality of degrees of freedom between an upper and a lower dental arch;
(b) simulating movement of said dental model while respecting said parameters to identify points of contact between portions of an upper and a lower dental arch, said resulting contacts being characterized by a sequence in time of occurrence;
(c) designing a change to said dental model taking into consideration said contact using a computer aided design system; and
(d) repeating as desired steps (b) and (c) to obtain a satisfactory changed dental model.

10. A method as claimed in claim 9, wherein said creating a virtual three dimensional model further comprises creating a virtual three dimensional model with respect to a mechanical articulator.

11. A method as claimed in claim 9, wherein said points of contact are identified by markers with different directions, lengths and colors.

12. A method as claimed in claim 9, further comprising identifying forces of contacts at said points of contact.

13. A method as claimed in claim 9, further comprising correlating an upper dental arch to a lower dental arch, said correlating comprising:
creating a physical dental model of said upper dental arch and said lower dental arch;
digitizing said physical upper dental arch along with reference markers referenced with respect to said physical lower dental arch model;
digitizing said physical lower dental arch along with reference markers with respect to said physical upper dental arch model; and
calculating transition matrices correlating said upper dental arch and said lower dental arch.

14. A method as claimed in claim 9, further comprising fabricating a prosthesis based on said satisfactory changed dental model using a computer-aided fabrication system.

15. A method for correlating an upper dental arch to a lower dental arch comprising:
creating a physical dental model of said upper dental arch and said lower dental arch;
digitizing said physical upper dental arch along with reference markers referenced with respect to said physical lower dental arch model;
digitizing said physical lower dental arch along with reference markers with respect to said physical upper dental arch model; and
calculating transition matrices correlating said upper dental arch and said lower dental arch.

16. A method as claimed in claim 15, further comprising applying a malleable material to said upper dental arch and said lower dental arch so as to create a bite impression of each in a desired occlusion position, said malleable material having said reference markers protruding from said dental model to provide an external referential system; and wherein said digitizing is done with said malleable material and without said malleable material.

17. A method as claimed in claim 15, wherein said reference markers are spheres and said digitizing comprises determining the center and diameter of each of said spheres.

18. A method as claimed in claim 17, wherein each of said spheres have different diameters so as to identify and differentiate them.

19. A method as claimed in claim 16, wherein said reference markers are polyhedrons having at least three faces visible from any point in space.

20. A method as claimed in claim 15, wherein said reference markers provide an external referential system referenced with respect to a mechanical articulator; and further comprising positioning said upper and lower dental arches within a virtual articulator using said external reference system.

21. A method as claimed in claim 20, wherein said virtual articulator has adjustable parameters corresponding to parameters of said mechanical articulator.

22. A method as claimed in claim 20, further comprising compensating for errors introduced by said digitizing by adjusting a virtual upper dental arch with respect to a virtual lower dental arch to a satisfactory occlusion.

23. A computer data signal embodied in a carrier wave comprising data resulting from one of simulating movement of a virtual dental model while respecting motion constraint parameters to identify points of contact between portions of an upper and a lower dental arch and designing a change to said dental model taking into consideration said contact using a computer aided design system.
